(19) United States
(12) Patent Application Publication
(10) Pub. No.: US 2025/0239806 A1
(43) Pub. Date: Jul. 24, 2025

(54) Flat Flexible Cable Seal and Method

(71) Applicant: TE Connectivity Solutions GmbH, Schaffhausen (CH)

(72) Inventors: Raghunandan Shrikanth Shanbhag, Bangalore (IN); Andrew Jacob Vasbinder, Middletown, PA (US); Patil Subodh, Winston Salem, NC (US)

(73) Assignee: TE Connectivity Solutions GmbH, Schaffhausen (CH)

(21) Appl. No.: 18/599,558

(22) Filed: Mar. 8, 2024

(30) Foreign Application Priority Data
Jan. 22, 2024 (IN) 202441004245

(51) Int. Cl. H01R 13/52; H01R 13/506

(52) U.S. Cl. CPC H01R 13/5205; H01R 13/506

(57) ABSTRACT

A seal assembly for a flat flexible cable, including: a subassembly having a cable opening sized to receive a flexible flat cable therethrough, and having a cover, a housing, the flexible flat cable, and a cable seal component having a central cavity; a header selectively connectable with the subassembly and configured to deform the cable seal component when connected, thereby creating an impermeable seal about the flexible flat cable. The cable seal component may be provided with sealing enhancements that improve the conformability against the narrow edges of a flexible flat cable and provide reliable and predictable sealing.

### CROSS-REFERENCE TO RELATED APPLICATIONS

This application claims the benefit of the filing date under 35 U.S.C. § 119(a)-(d) of Indian Patent Application number 202441004245 filed Jan. 22, 2024.

### FIELD OF THE INVENTION

The present invention relates to electrical devices, and more particularly, to a seal for a flat flexible cable.

### BACKGROUND

Flat flexible cables (FFCs) or flat flexible circuits are electrical components consisting of at least one conductor (e.g., a metallic foil conductor) embedded within a thin, flexible strip of insulation. Flat flexible cables are gaining popularity across many industries due to advantages offered over their traditional “round wire” counter parts. Specifically, in addition to having a lower profile and lighter weight, FFCs enable the implementation of large circuit pathways with significantly greater ease compared to a round wire-based architectures. As a result, FFCs are being considered for many complex and/or high-volume applications, including wiring harnesses, such as those used in automotive manufacturing.

A critical obstacle preventing the implementation of FFCs into these applications includes the need to develop quick, robust, and low resistance termination techniques which enable an FFC to be mating with various components. Moreover, these applications often subject the FFCs and their associated connectors to harsh environmental contaminants, such as dirt and moisture. Accordingly, reliably terminating the FFCs includes sealing their connectors from these elements. However, reliably creating a seal about an FFC, as well as sealing the mating connectors associated therewith, has proven challenging. In particular, forming a fluid impermeable seal against the entire surface profile over a portion of the FFC, particularly where the narrow edges of the thin FFC are to be sealed and requiring a seal that can reliably conform around the narrow edges has shown to be difficult.

Accordingly, cost effective and reliable solutions for reliably sealing FFC assemblies are desired.

### SUMMARY

In one embodiment of the present disclosure, a seal assembly for a flat flexible cable (FFC) is provided, the seal assembly including a cover, a housing, a header and a seal made of an elastomeric body defining a central cavity through which a FFC can be directed and sealed. The seal is configured to be retained within the other assembly components, and be compressed when the assembly is assembled, in order to provide a predictable seal by conforming the seal against the periphery of the FFC. The seal is also to provide an impermeable seal by being compressed against, and seal with each of the cover, the housing, the header, in addition to the FFC. In an embodiment the seal body includes seal enhancing features such as relief wells, or sealing zones that are more conformable than the balance of the seal body. The sealing zones may be gel filled hollow region of the seal body, or a softer durometer material.

### BRIEF DESCRIPTION OF THE DRAWINGS

The invention will now be described by way of example with reference to the accompanying Figures, of which:

FIG. 1 is a perspective view of an exemplary FFC cable useful for describing embodiments of the present disclosure;

FIG. 2A is an exploded perspective view of a connector assembly utilizing an FFC seal according to an embodiment of the present disclosure;

FIG. 2B is a reverse perspective exploded view of the connector assembly of FIG. 2A;

FIG. 3A is a perspective view of an exemplary embodiment of the FFC seal of FIG. 2A;

FIG. 3B is a reverse perspective view of the FFC seal of FIG. 3A;

FIG. 4 is a perspective view of another exemplary embodiment of an FFC seal according to the present disclosure;

FIG. 5 is an exemplary embodiment of a seal having a sealing zone adjacent to each side of the central cavity; and

FIGS. 6A, B and C are cross-sectional views of the FFC assembly 100 depicting the progression of forming an effective FFC seal, with the exemplary seal of FIG. 2A as it is installed within a connector subassembly and subsequently the header is placed within the FFC assembly.

### DETAILED DESCRIPTION OF THE EMBODIMENTS

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

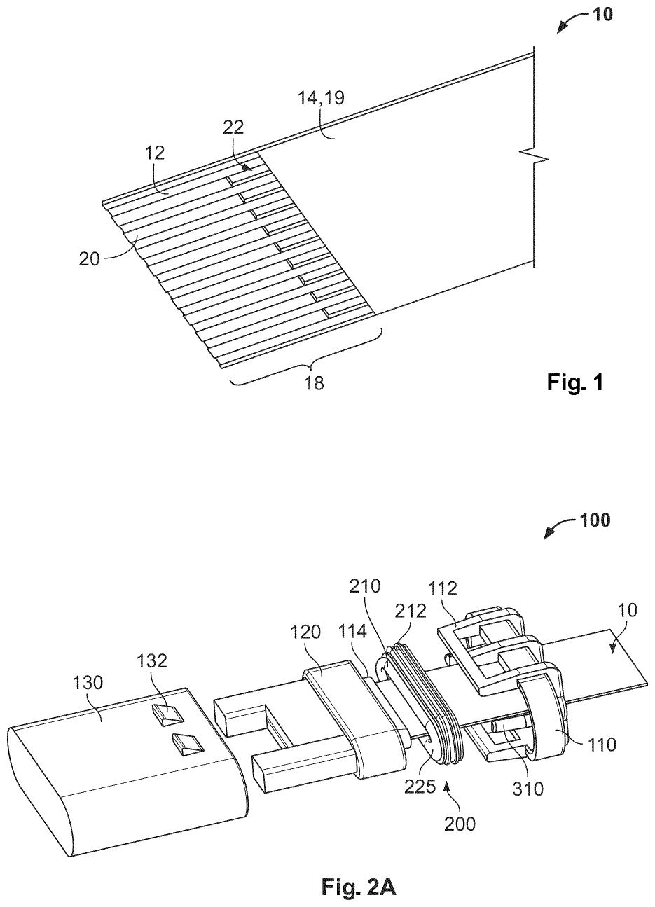

FIG. 1 illustrates an exemplary portion (i.e., an end segment) of an FFC 10. The exemplary FFC 10 includes a plurality of conductors 12 embedded within an insulating material 14. The conductors 12 may comprise metallic sheet or foil, such as copper foil, by way of example only, patterned in any desirable configuration. The insulating material 14, such as a polymer insulating material, may be applied to either side of the conductors 12 via an adhesive, resulting in an embedded conductor arrangement. One or more portions or windows of the insulating material 14 may be removed (or may not be initially applied) in select areas to expose sections of the otherwise embedded conductors 12. In the exemplary embodiment, a portion of a top surface 19 of the insulating material 14 has been removed to define a single continuous window 18 exposing the ends of each of the conductors 12 on a top side thereof, while a bottom portion 20 of the insulating material 14 remains present for added stability and strength. A plurality of openings 22 may optionally be formed through the FFC 10 between each pair of adjacent conductors 12. In such an embodiment, the openings 22 may be sized and positioned to receive locking clips or latches of electrical terminals to be attached to the FFC 10.

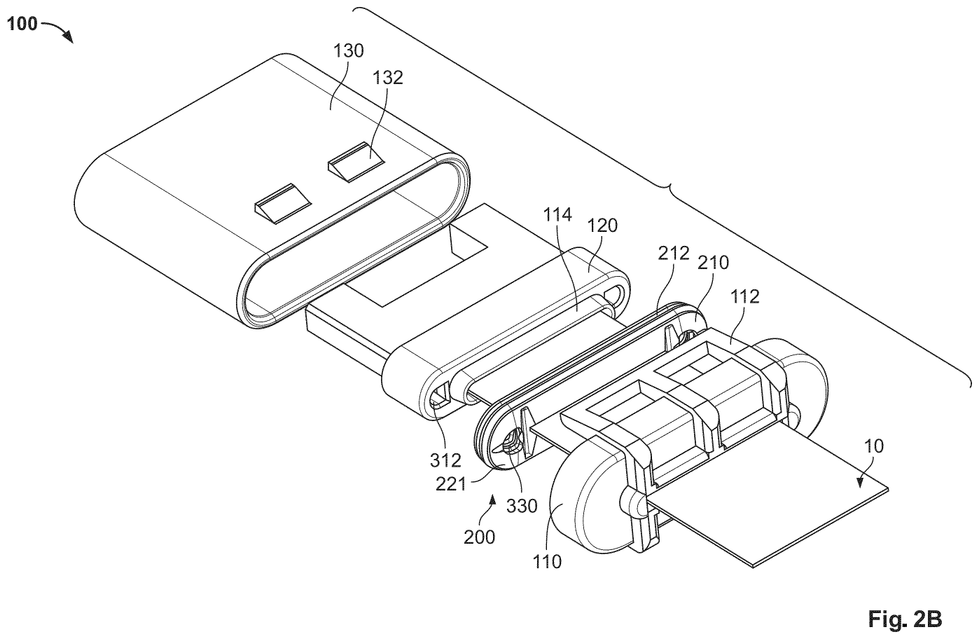

Referring to FIG. 2A, an FFC assembly 100 according to an embodiment of the present disclosure includes an FFC 10 electrically connected to a plug housing 120. The plug housing is adapted to selectively connect to a mating connector or header 130. In order to seal the FFC/plug interface, a seal 200 according to an embodiment of the present disclosure is fitted over the FFC 10.

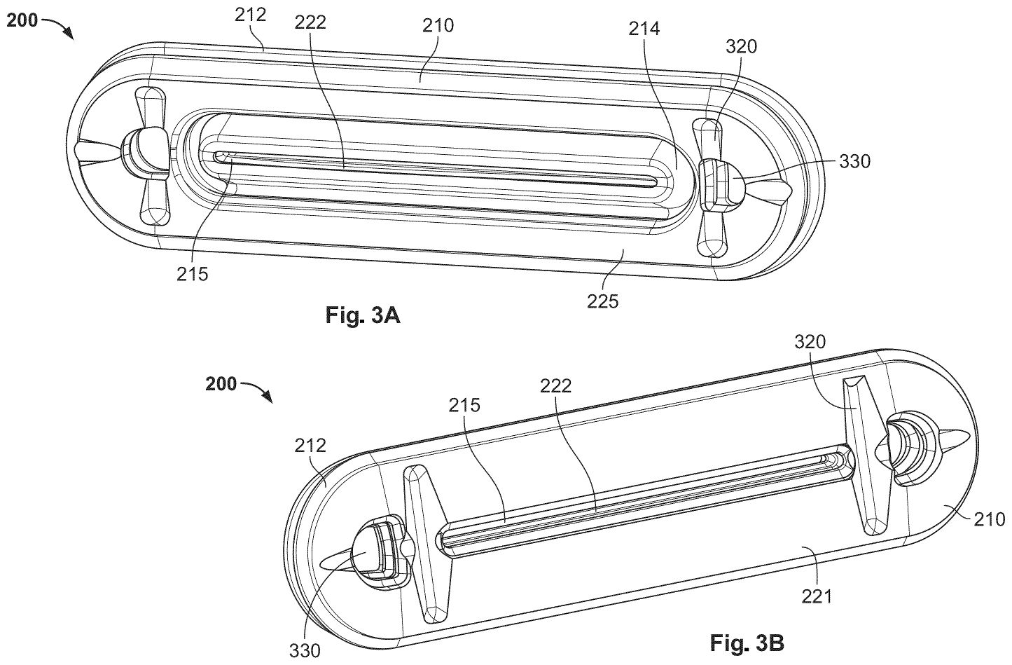

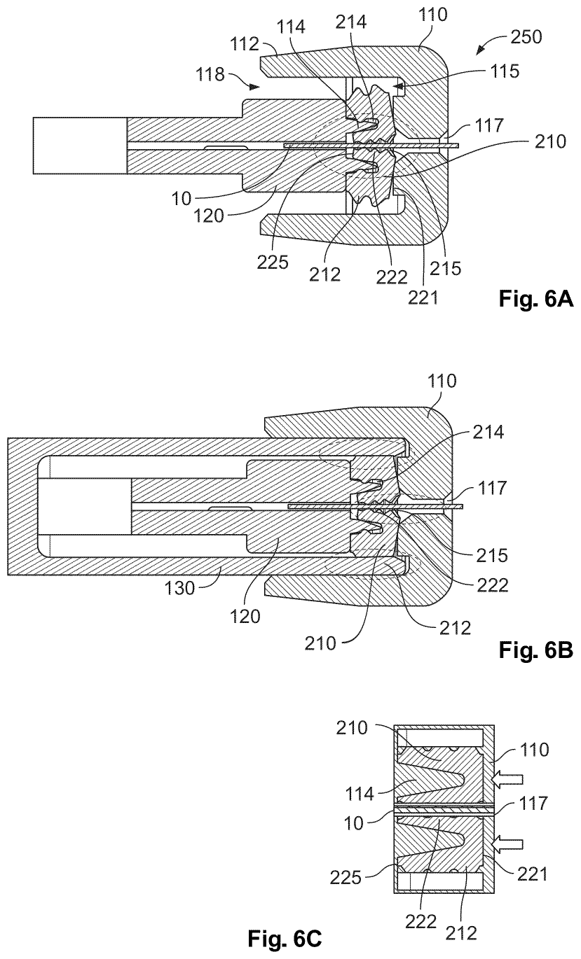

The FFC assembly 100 further includes a cover 110, which may comprise a monolithic, polymer element formed via a molding process. The exemplary cover 110 defines at least one elastic latch 112 extending in a mating direction for engaging with a corresponding catch 132 formed on the header 130, and selectively fixing the cover 110 onto the header. In an embodiment, there are a pair of elastic latches 112 on the cover 110 to secure to corresponding catches 132 positioned on opposing surfaces of the header 130, as can be seen with reference to FIG. 2A. The cover 110 further defines a slotted opening 117 on a front end thereof that is sized to receive the FFC 10 therethrough, and a rear opening 118 adapted to receive the header 130. See FIGS. 6A-C. When assembled, exterior sealing ribs 212 of the seal 200 abut or sealingly engage about its perimeter with an interior wall defining an opening in the header 130, as can be seen with reference to FIG. 6B. Under a compressive force maintained by the engaged latches 112 on the cover 110 and catches 132 on the header 130, one axial facing surface 221 (see FIG. 3B) of the seal 200 engages the cover 110, with the opposite side engaging or abutting the plug housing 120, as shown in FIGS. 6A and 6B.

It should be understood that the connector assembly shown in FIGS. 2A and 2B is merely representative, and the FFC seals and methods of manufacturing the same described herein may be used in any other suitable application without departing from the scope of the present disclosure.

As shown in the Figures, the seal 200 may be provided with sealing features (e.g., ribs) facing externally (external facing ribs 212) to engage with a portion of a connector (e.g., the inside of the header 130), as well as internally (internal facing ribs 222) for engaging with the surface of a cable (e.g., the FFC 10). However, an adequate seal with the thin, flexible FFC may require additional sealing features, as the seal must be able to reliably conform against the narrow side edges of the ribbon-like cable. As will be discussed, by varying the different properties of the seal in the region surrounding or adjacent to the edges of the cable (e.g., controlling the properties of the materials, including rigidity or durometer, or providing relief wells or slits, etc.), effective seals 200 may be molded that more readily conform against the exterior profile of the FFC 10, when compressed within the FFC assembly 100. For example, the present invention provides a seal that is able to conform against the major planar surfaces on the top and bottom of the flexible flat cable, and moreover also adequately seal against the relatively narrow edges forming minor surfaces extending the thin sides of the FFC that can present a challenge. In an embodiment of the invention, the effective sealing against the minor surfaces of the FFC may be provided by compressing the seal 200 in manners described herein, wherein the seal compression may be applied in multiple stages or forms; for example, the staged compression may be applied in consecutively implemented stages, or alternatively, the seal compression may be applied in multiple manners and substantially simultaneously as the connection is made between the components of the FFC assembly 100. In an embodiment, compression of the seal may be created by securing the seal around an FFC within a plurality of zones corresponding to the portion of the seal 200 that is between: the cover and housing; and/or between the header and housing; and/or between the cover, housing, and header. In various embodiments, as will be discussed, the seal 200 may further be provided with features that provide enhanced sealing around the FFC, especially at the narrow edges of the cable where the seal must conform in a tight bend around the narrow thickness dimension of the FFC, thereby reliably providing adequate sealing at the outside side edges of the FFC.

Referring to FIGS. 3A, B and 6A,B, an embodiment of the present disclosure provides a seal 200 with internal sealing features such as one or more ribs 222 that can each be caused to separately conform to the flat surfaces and side edges of a FFC. Specifically, the seal 200 according to embodiments of the present disclosure includes a body 210 defining an internal cavity 215 therethrough. The body 210 may be formed from flexible polymer material (e.g., silicone rubber, nitrile rubbers, or polyurethanes, fluoroelastomers, ethylene propylene diene monomer rubber, chloroprene, perfluoroelastomer, or fluorosilicone, as non-limiting examples) having a relatively low shore durometer (e.g., 70-85 A).

The body 210 defines multiple distinct seal portions or zones. A first seal portion of the seal body 210 is formed about the exterior profile, with external sealing ribs 212 extending about an exterior perimeter thereof. In the exemplary embodiment, each sealing rib 212 tapers in a radially outward direction for defining a sealing surface or tip. Another seal portion of the seal body 210 is provided on a second axial face 225 of the body 210, as openings configured either circumferentially about the internal cavity in an obround shape, or merely in sections, where the body 210 defines cavities 214 therein which open in an axial direction. The cavities 214 are adapted to receive portions of a connector component therein, such as the housing 120 (see FIG. 6A-C), providing both structural support for the seal 200, as well as positioning functions.

Still another seal portion or zone is formed in the interior of the seal body 210, within internal cavity 215. As shown, internal cavity 215 is provided with internal facing sealing ribs 222 extending about the internal cavity 215 (e.g., extending entirely along the lining of the internal cavity), with the internal sealing ribs 222 that are dimensionally smaller than the sealing ribs 212 but are similarly provided in the form of multiple internal facing sealing ribs 222 now where each sealing rib 222 is tapered radially towards the internal cavity through which the FFC is to pass.

Additionally, each axial facing surface of the seal body 210 provides still other sealing portions or zones; with the first axial facing surface 221 of the seal 200 engaging the cover 110, and with the second axial facing surface 225 engaging or abutting the plug housing 120, with an obround protrusion on the housing 120 received within a corresponding cavity 214 of the second axial facing surface 225, as shown in FIGS. 6A, B and C.

As shown in FIGS. 3A and 3B, the seal 200 is generally defined as a hollow obround shape, having generally semi-circular ends with linear portions extended between the ends. It should be understood that other seal cross-sections or shapes may be incorporated without departing from the scope of the present disclosure, however.

Referring now to FIG. 6A, a sub-assembly 250 prior to introduction of the header 130 is depicted, as shown the sub-assembly 250 includes the seal 200 installed against the housing 120 and further with the seal 200 installed within the cover 110 of FIG. 2A, with a portion of the FFC 10 passing through the opening (central cavity 215) in the seal body 210. The housing 120 includes at least one projection 114 extending axially towards the seal 200, and the projection 114 engages with the at least one cavity 214 of the second axial face 225, securing the seal 200 to the housing 120. This arrangement also isolates the sealing surfaces defined by respective sealing ribs 212, 222 from one another, allowing their relatively independent operation. The seal 200 creates a receiving space 115 within the cover 110 extending about the perimeter of the seal. The receiving space 115 is sized to receive an end portion of the header 130, by way of example only, and generate a seal with an internal wall thereof via the sealing ribs 212 (as shown in FIG. 6B and in greater detail in FIG. 6C). The internal facing sealing ribs 222 provided on the perimeter of the internal cavity 215 are in alignment with the slotted opening 117 of the cover 110 for receiving the FFC 10 therethrough. The first axial facing surface 221 is oriented in a direction to abut and seal against the interior surface of the cover 110 in the sub-assembly 250. The cover 110 may optionally provide at least one protruding prong 310 extending away from the axial inside face of the cover 110 in a direction towards the housing 120, as can be seen with reference to FIG. 2A. As shown, in an embodiment, there are provided a pair of rearward protruding prongs, each in the shape of a tapered semicircular prism, that may be directed through corresponding relief openings 330 in the seal body 210, and be received within a corresponding receiver opening provided in the housing 120 in a location that will ensure proper alignment of the cover 110 and housing 120 as they are approximated to each other, as well as retain the seal 200 in position against the cover 110, for example, within the sub-assembly 250 prior to being engaged with a header 130.

With reference to FIG. 6B, the header 130 is depicted having been engaged with the sub-assembly 250 of FIG. 6A, by having been fitting over housing 120, and urged towards the cover 110, with the end of the header 130 directed into the receiving space 115. The header 130 may then be mechanically secured with the cover 110 as the elastic latches 112 of the cover 110 are caused to selectively engage with the one or more catches 132 (shown in FIG. 2A) provided on the major surfaces of the header 130. The engagement of the elastic latches 112 and the catches 132 can maintain a compressive force applied against the seal 200 between the cover 110, the housing 120, and the header 130, and thereby also tightly conform the seal 200 against the FFC 10.

Thus, the engagement of the header 130 to the seal sub-assembly 250 will cause the seal 200 to be compressed to a higher degree than as provided in FIG. 6A, and as shown in FIG. 6B, the seal 200 is caused to seal in a plurality of sealing zones as described herein. In this manner, the seal body 210 is to be urged into sealing conformations as the sub-assembly 250, when assembled with the header 130 will apply compression in the multiple zones of the seal 200 as described, in order to achieve an effective seal about the FFC 10 within the header 130, housing 120, and cover 110.

Initially, and with reference to the sub-assembly 250 of FIG. 6A, the seal 200 is provided compressed about the FFC cable 10 that is directed through slotted opening 117 of the cover 110, and the FFC is passing through interior cavity 215 of the seal 200. As shown, at least one of the interior facing ribs 222 is shown to be in contact with, and may optionally be deformed against the exterior profile of the FFC 10 that is directed through the interior cavity 215. In this subassembly compression stage of the seal 200, as depicted in FIG. 6A, none of the exterior facing ribs 212 would be compressed against any other component of the sub-assembly 250, rather the exterior facing ribs would extend at least partly into the receiving area 115. It is contemplated that, in an alternative embodiment, all of the interior facing ribs 222 may be in contact with and may further have some or all of the interior facing ribs 222 optionally compressed against the FFC provided within the sub-assembly 250. As depicted in FIG. 6A, depicting the subassembly 250, prior to the introduction of the header 130, the first axial sealing face 221 of the seal 200 may be in contact with the inside axial face of the cover 110 but is not urged tightly against and conforming against the inside axial face of the cover 110. Similarly, the second axial facing surface 225 of the seal 200 may also be in contact with the vertical axial facing surfaces of the housing 120, but not tightly conformed against those surfaces. Similarly, the projection 114 of the housing 120 is shown extended into the cavity 214, but the seal 200 is not deformed fully against the projection 114, as demonstrated by the spacing remaining within the cavity 214, even with the projection 114 extended therein.

The deployment of the header 130 over the housing 120 is depicted in FIG. 6B, with the cover 110 to be secured to the header 130 by the elastic latches 112 latching onto the catches 132. As shown in FIG. 6B, the end portion of the header 130 is directed over and past the exterior facing ribs 212 of the seal 200, which in turn would urge the seal body 210 into a second stage of compression, characterized by having provided impermeable sealing at more zones or regions when compared to the embodiment depicted in FIG. 6A. As shown in FIG. 6B, each of the external facing ribs 212 are in contact with, and deformed against the interior surface of the header, as the header 130 is caused to occupy the void spaces 115 adjacent to the external ribs 212, as depicted in FIG. 6A. With the header 130 positioned against and creating an impermeable seal by the deformation of all of the external sealing ribs 212, the seal body 210 would be subject to compression, such that the at least one cavity 214 of the seal is tightly deformed or urged against the projection 114 of the housing 120 (as shown in FIG. 6C). Furthermore, the advanced stage of the compression of the seal body 210 will have all of the interior facing sealing ribs 222 deformed against the FFC, to form a reliable, impermeable seal in the region of the seal 200 that is in contact with the outside surfaces of that portion of the FFC 10, as depicted in FIG. 6C. Additionally, the cover 110 will be urged towards the header 130 (in the direction of the arrows) and the cover and header can then be secured relative to each other by the engagement of the elastic latches 112 and the catches 132, causing the first axial facing surface 221 to now be tightly conforming against the interior axial face of the cover 110, as depicted in FIG. 6C. Similarly, the second axial facing surface 225 would be compressed against the vertical face surfaces of the housing 120. In this manner, an impermeable seal would be created at multiple interfaces within the FFC assembly 100, including the interfaces between the: interior sealing ribs 222 and FFC 10; exterior sealing ribs 212 and header 130; projection 114 and cavity 214; first axial facing surface 221 and cover 110; and second axial facing surface 225 and housing 120. With the impermeable seal formed and maintained at each of these interfaces, the FFC assembly 100 according to the present invention ensures that the connection of the FFC 10 for carrying electrical signals is moisture and dirt resistant.

Optionally, and as depicted in FIG. 2A, the cover 110 may have at least one locating pin, depicted as a tapered prong 310 extending in an axial direction away from the face of the cover 110, in a direction towards the housing 120, where the at least one tapered prong 310 can be received within the locating openings 330 provided in the seal 200 depicted in FIGS. 3A and 3B. Each of the prongs 310 of FIG. 2A may be received within a corresponding receiving hole 312 provided on the face of the housing 120, as shown in FIG. 2B. In an embodiment, the transition from the axial facing surface 221 into the location opening 330 may be chamfered or rounded over, in order to ease the entry and passage of the prongs 310 through the locating openings 330. As depicted in FIGS. 2A and 2B, in an embodiment there are two tapered prongs 310, positioned on either side of the elongated slotted opening 117 of the cover 110. As the tapered prongs 310 are passed further through locating openings 330 in the seal body 210, with the narrower part of the prong 310 initially entering, and the prong progressively increasing in dimension as the tapered prong 310 is inserted further through the relief opening, the final portion of the prong closest to the cover 110 may transition to a non-tapered portion (e.g., a right semi-circular prism body), such that the locating opening will conform around the prong, and not be urged to slide away from the cover 110. In this manner, the seal 200 would tend to remain secured in place with the locating opening 330 encircling and gripping against the periphery of the non-tapered base portion of the locating pin. It is further contemplated that after passing the locating pins through the locating openings 330 of the seal body 210, the tapered prong 310 may be received within a corresponding receiving hole 312 provided in the housing 120. In this manner, the tapered prong(s) 310 of the cover 110 will serve to retain the seal body 210 in place within the sub-assembly 250, ensure proper location of the cover 110 and the housing 120 relative to each other, and further may physically engage the cover 110 to the housing 120, e.g., wherein the prong 310 is friction fit within the corresponding receiving hole 312 in the housing 120. Still further, with the prong(s) 310 received within the corresponding receiving holes 312 of the housing 120, the introduction of the header 130 into the receiving space 115 of the sub-assembly 250 would not tend to displace or dislodge the cover 110 away from the housing 120.

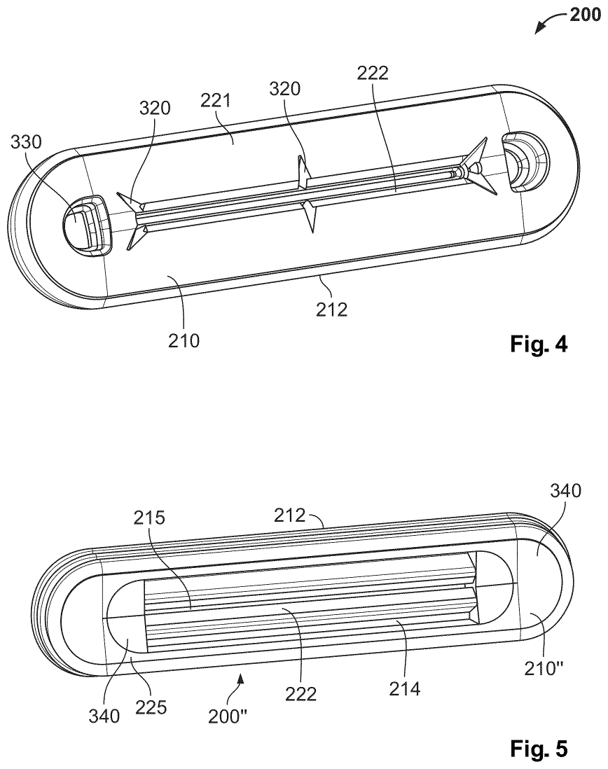

In an embodiment the seal body 210 may optionally be provided with at least one sealing enhancement that is configured to improve the ability of the seal body 210 to conform to the entirety of the exterior profile of the FFC 10 as it is directed through the internal cavity 215. In an embodiment, the at least one sealing enhancement serves to increase, at least in a localized area, the deformability of the seal body 210, specifically, by providing greater conformability for each region of the seal body 210 that is adjacent to the ends of the internal cavity 215, so as to allow the seal body 210 to deform more readily in these regions and reliably conform against the narrow edges of the FFC 10, in order to ensure a reliable seal around the narrow sides of the FFC 10. In the embodiment depicted in FIGS. 3A and 3B, as well as FIG. 4, the seal body 210 may contain one or more grooves or recesses in the seal body, provided as relief wells 320 that serve to increase the ability of the seal body 210 in localized regions to relieve deformation and compressive pressure in the seal body 210, and thereby minimize localized stresses that might accumulate and cause unpredictably deformation as the header 130 is introduced to the sub-assembly 250 and the seal 200 is caused conform against each of the cover 110, housing 120, header 130 and FFC 10, in order to provide an impermeable seal for the FFC assembly 100.

As shown in FIGS. 3A and 3B and FIG. 4, the seal body 210 may be provided with one or more exemplary partial thickness relief wells, which may be cuts or slits, shown as relief wells 320 provided in targeted locations, in the vicinity of the location openings 330 and at each end of the internal cavity 215, in order to enhance the flexibility and conformability of the seal body 210 in the targeted region. The partial thickness relief cuts may be provided on just one, or both of the first axial facing surface 221 and the second axial facing surface 225 of the seal 200. It is contemplated that, in an exemplary embodiment, the relief wells 320 provided on the first axial facing surface 221 may be mirror image versions of the relief wells provided on the second axial facing surface 225. Alternatively, in another exemplary embodiment, it is contemplated that the relief wells 320 provided on one axial facing surface may be different than those provided on the opposing axial facing surface. In an embodiment, it is contemplated that relief wells may be provided on only one of the first or second axial facing surfaces 221, 225.

Specifically with reference to FIGS. 3A and 3B, the relief wells 320 in the depicted embodiment may be provided on each of the first axial facing surface 221 and second axial facing surface 225 of the seal 200 and may be different on each face. The relief wells 320 serve to provide greater flexibility and conformability in targeted regions of the seal body 210, where the relief provided is a shaped concavity or hollow provided in the seal body 210, where the relief well provides a reduction in the thickness of the material of the seal body 210, relative to the surrounding area of the seal body. The thinner profile of the material in the relief wells 320 will more easily stretch when deformed, relative to the portions of the seal that are not thinned, and moreover, the relief afforded within the well 320 will allow displacement of the surrounding material into the relief when the seal 200 is compressed. Thus, the relief well 320 is configured to allow the seal body 210 to more easily flex and predictably deform in order to better conform to the FFC 10, particularly at the narrow edges of the FFC, as it is passed through the internal cavity 215. Additionally, the relief wells 320 thus can relieve at least some of the pressure owing to the deformation of the seal body 210 material as it is compressed within the other components of the FFC assembly 100 (e.g., the header 130, housing 120, cover 110 and FFC 10), thereby minimizing irregular or unpredictably deformation as the material of the seal 200 is compressed and caused to deform and can be displaced into the open region created within the relief well 320.

In an embodiment, the relief well 320 may be created after molding of the seal body 210, by the excision and removal of specific material from the seal body 210 after molding in order to create the relief cut, for example by being cut or milled away; or alternatively, the relief well may be integrated into a mold, or provided when the material for the seal body 210 is initially formed (e.g. injection molded, milled, or cast) to the desired form.

In the exemplary embodiment depicted in FIGS. 3A and 3B, the relief wells 320 are shown as partial thickness relief cuts or openings that allow easier deflection to the narrow strip remaining between the ends of the internal cavity 215 and the respective locating opening 330. As shown, in an exemplary embodiment, the relief wells 320 may in the form of generally rounded grooves forming recesses into the seal body 210 (FIG. 3A), and generally lacking sharp corners or edges within the interior of the recess; or alternatively, in another exemplary embodiment, the relief wells 320 may be angular recesses provided in the seal body 210 (FIG. 4) characterized by having planar surfaces meeting at intersection lines, and the recess having distinct corners within the recess.

With reference specifically to FIG. 3A, the relief wells 320 include a minor relief cut positioned between the outside edge of the seal body 210, and extending towards the locating opening 330, positioned longitudinally along a plane extending through the elongated central cavity 215. The relief wells 320 of FIG. 3A also include a pair of transverse grooved recesses, each positioned on either side of the central cavity, outside of the edge of the obround cavity 214 on either side, and extending across the respective locating opening 330, with the cut positioned perpendicularly to a plane extending through the central cavity 215.

With reference specifically to FIG. 3B, the relief wells 320 include a minor relief cut positioned longitudinally along the plane of the central cavity 215 and extending nearly from the outside edge of the sealing body 210 and extending across the respective locating opening 330, until encountering one of the transversely oriented relief wells 320. As shown, each transverse relief well 320 is oriented perpendicular to a plane extending through the central cavity 215 and is positioned between the respective locating opening 330 and the respective end of the central cavity 215, with the relief well extending nearly the full dimension of the seal body 210 transverse to the plane of the central cavity 215. The transverse relief cuts 320 of FIGS. 3A and 3B may be generally tapered towards the center line of the cut, with rounded ends, as shown.

With reference to FIG. 4, in another exemplary embodiment, the seal enhancement may be a plurality of relief wells 320, provided as recesses in the form of 3-dimensional tapered wedge slits, for example, as shown extending and tapered by narrowing in a direction away from the corners at each of the ends of the central cavity 215, at approximately a 45 degree, relative to the plane passing through the central cavity. In the embodiment of FIG. 4, there may further be provided a pair of relief wells 320 positioned at an approximate center along the length of the central cavity 215, with each of these relief cuts being tapered and extending in a direction transvers from the central cavity 215 and extending approximately one half the distance from the central cavity to the outer perimeter of the seal body 210.

In another embodiment, as depicted in FIG. 5, the sealing enhancement feature may be in the form of a sealing zone 340 provided at each end of the seal 200″, in the region that is adjacent to each end of the elongated central cavity 215. In an exemplary embodiment, the sealing zone 340 is characterized by being of a material that has different properties than the balance of the seal 200″, for example, the sealing zone 340 may be of a material that is more conformable than the balance of the material of the seal 200″. The providing of sealing zones 340 that are more conformable may be achieved, for example, by providing at each end of the central cavity a region of the seal body 210″ that is formed of a material, such as a polymer, having a less rigid material property, and having a lower shore durometer (e.g., <80 A) durometer when compared to the balance of the sealing body 210″, such that the sealing zone 340 will more readily deform around and conform against the side edges of a ribbon shaped FFC 10 that is passed through the central cavity 215, as discussed previously. In an embodiment, the sealing zones 340 may be formed by any suitable manufacturing or molding process, such as an injection molding process utilizing an overmolding technique, in order to provide a unitary sealing body 210″ having regions with different durometers in the unitary body.

In an alternative embodiment, it is contemplated that the sealing zone 340 may be provided as a hollow region created within the seal body 210″ within the sealing zone 340 and the hollow may be filled or injected with a conformable gel material, such that the gel of the gel-filled region may be physically displaced within the sealing zone 340, and thereby accommodate and conform against an FFC that is directed through the central cavity 215, in the manner previously described. In this manner, as the FFC 10 is directed through the central cavity 215, and the edges of the FFC encounter the respective sealing zone, the flowable gel material can be displaced and resulting in the gel-filled interior of the sealing zone within the sealing body 210″ readily conforming against the narrow dimensions of the side edges of the FFC 10, in order to provide a seal against the edges of the FFC. In an embodiment, the sealing zone 340 of the sealing body 210″ may contain a visco-elastic gel substantially filling the hollow interior portion of the sealing zone 340, which can conform to the portion of the FFC directed through the central cavity but will seek to return to the original shape if the FFC is removed from the central cavity 215.

In any of the embodiments of FIG. 5, the sealing zone 340 provided may be, as depicted, a semicircular shaped region adjacent to each end of the central cavity 215 and having a radius that is approximately the same as the distance from the central plane of the central cavity 215 to the outside edge of the obround cavity 214 positioned above or below the central plane. It is contemplated that alternative shapes for the sealing zone may be provided and not depart from the spirit of this disclosure, including, as non-limiting examples, any suitable shape such as crescent, square, triangular, or rectangular sealing zones, or regular or irregular polygonal or curved shapes.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present disclosure are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. A seal assembly for a flat flexible cable, including:
a subassembly having a cable opening sized to receive a flexible flat cable therethrough, and having a cover, a housing, the flexible flat cable, and a cable seal component having a central cavity;
a header selectively connectable with the subassembly and configured to deform the cable seal component when connected, thereby creating an impermeable seal about the flexible flat cable.

2. The seal assembly of claim 1 wherein the cable seal component comprises a plurality of exterior sealing ribs extended around the exterior of the cable seal component, and a plurality of interior sealing ribs extended around the central cavity.

3. The cable seal assembly of claim 2 wherein the cable seal component further comprises a first axial face that is positioned in a direction facing the cover, and a second axial face positioned in a direction that is facing the housing.

4. The cable seal assembly of claim 3, wherein the housing has a projection arranged about the cable sized opening, and the cable seal component provides a cavity in the second axial face that is configured to receive at least a part of the projection therein.

5. The seal assembly of claim 4, wherein the projection of the housing is tapered in cross-section, and is obround in shape, and wherein the cavity in the second axial face is a cavity that is tapered in cross-section and is obround in shape.

6. The cable seal assembly of claim 4, wherein the cover has at least one locating pin, the cable seal component has at least one locating opening, and the housing has at least one receiving hole, such that the locating pin passes through the locating opening and is received at least partially within the receiving hole.

7. The cable seal assembly of claim 6, where in the cover has a pair of locating pins that are positioned to each side of the cable opening, the cable seal assembly has a pair of locating holes each receiving one of the locating pins therethrough, and the housing has a pair of receiving holes each receiving at least part of the respective locating pin.

8. The cable seal assembly of claim 6 wherein the locating pin is a tapered semicircular prong having a non-tapered base where the locating pin is secured to the cover.

9. The seal assembly of claim 4, wherein the header comprises at least one catch, and the cover comprises at least one latch configured to be engaged with the catch to secure the cover to the header.

10. The seal assembly of claim 9, wherein the securement of the cover to the header causes the cable seal component to seal in a plurality of zones.

11. The seal assembly of claim 10, wherein the plurality of zones includes a first zone comprising the interface between the exterior sealing ribs and an interior surface of the header, a second zone comprising the interface between the first axial face and the cover, the third zone comprises the interface between the second axial face and the housing, and the fourth zone comprises the interface between the interior sealing ribs and the flexible flat cable.

12. The seal assembly of claim 10, wherein the third zone further comprises the interface between the projection of the housing, and the cavity of the second axial face.

13. The seal assembly of claim 4, wherein the cable seal component further comprises at least one sealing enhancement.

14. The seal assembly of claim 13, wherein the sealing enhancement provides improved conformability of the cable seal component to a pair of edges of the flexible flat cable.

15. The seal assembly of claim 13, wherein the at least one sealing enhancement is selected from the group consisting of a relief well, and a sealing zone.

16. The seal assembly of claim 15, wherein the at least one sealing enhancement comprises a plurality of relief wells, each relief well of the plurality of relief wells selected from the group consisting of a grooved recess having rounded features, and a 3-dimensional tapered wedge slit.

17. The seal assembly of claim 15, wherein the at least one sealing enhancement comprises a plurality of sealing zones, each sealing zone of the plurality of sealing zones positioned at each end of the central cavity.

18. The seal assembly of claim 17, wherein the sealing zone comprises a material having a less rigid durometer than the balance of the cable seal component.

19. The seal assembly of claim 17, wherein the sealing zone comprises a hollow region having a conformable gel material therein.

20. The seal assembly of claim 19, wherein the conformable gel is a viscoelastic gel.
